(19) United States
(12) Patent Application Publication
(10) Pub. No.: US 2012/0306998 A1
(43) Pub. Date: Dec. 6, 2012

(54) Macro Area Camera for an Infrared (IR) Microscope

(76) Inventors: Dennis E. Merrill II, Littleton, MA (US); Federico Izzia, Middleton, WI (US)

(21) Appl. No.: 13/150,847

(22) Filed: Jun. 1, 2011

(51) Int. Cl. H04N 7/00

(52) U.S. Cl. 348/36

(57) ABSTRACT

A novel arrangement of Schwarzschild Cassegrainian objective coupled with a far-field visible imaging system that does not interfere with the interrogating (IR) beam is introduced. Typical (IR) microscopes that incorporate a Cassegrainian objective have difficulty in locating desired target sample regions based on the inherent limited field-of-view. Because commonly applied visible imaging accessories upstream must use the same numerical aperture based on the reflective geometry, such systems also suffer a limited field of view. To overcome such difficulties, the novel embodiments herein involve placing a visible camera with its optical axis collinear with the IR and primary visible beampath of the microscope but outside the optical path that provides the (IR) image magnification.

### BACKGROUND OF THE INVENTION

1. Field of the Invention

The present invention relates to the field of optical microscopy. More particularly, the present invention relates to a novel reflective infrared microscope objective that enables simultaneous viewing of both, the area of interest and a significantly wider field of view.

2. Discussion of the Related Art

Infrared (IR) and in particular Fourier Transform infrared (FTIR) microscope systems enable optical spectroscopic interrogation of substantially small samples (e.g., areas of about 25 μm×25 μm) by mapping the acquired image data of a larger area of a sample with a defined spatial resolution. Accordingly, a beneficial aspect of the FTIR microscope is the ability to collect infrared spectra from a much smaller, defined area of the sample matrix. FTIR microscopy in particular can provide spectral information of a very small contaminant embedded in a sample or particular details regarding chemical constituents or other types of spatial information. Applications using such microscopes can include, but are not limited to, biochemistry analysis, chemical analysis, polymer analysis, pharmaceutical and materials analysis, and forensics.

In an FTIR microscope, the objective can be of the Cassegrain arrangement and have, for example, between about 15× and 40× magnifications, which require the optic to have a large numerical aperture and a small field of view. It is widely accepted that using reflective optics in such Cassegrain arrangements is a better approach than using transmissive optics because the use of such reflective e components provide for a wide spectral range with lower reflective losses and minimal chromatic aberrations. Moreover, since reflective optics has no wavelength band-pass/cut-off limitations, they can be used for visual observation as well as to collect infrared data.

However, using reflective optics limits the flexibility the designer has when developing a microscope with an appropriate magnification but with a desired visible wide field-of-view for targeting desired samples and often makes variable magnification impractical. To compensate, such microscopes can be configured with, for example, either a flip aluminum coated mirror or a dichroic (IR reflective/visible transparent) mirror to enable a user to observe and collect data without changing the objective or magnification while nonetheless achieving the coaxial beampath of visible and IR light. This particular arrangement, however, has provided for a long-standing problem in the field of IR microscopy because, as known to one of ordinary skill in the art, although the visible field-of-view tends to be somewhat larger than the infrared field-of-view despite traveling through the same microscope beampath, the visible arrangement is still quite restricted by the numerical aperture (NA) and magnification of the objective.

As a way around such a restriction, the acquisition of larger field-of-view images alternatively can be accomplished by stitching multiple frames (also known as “mosaic” image) in any infrared microscope equipped with a motorized sample stage. However, this procedure also shows some inconveniences, such as: 1) the quality of the stitched, reconstructed image is subject to stage calibration and alignment accuracy to image vignetting and other illumination artifacts 2) the time required to acquire a large image composed by hundreds of frames significantly compromises the overall measurement cost per analysis 3) the illumination through the microscope objective is subject to intrinsic power of the visible light illuminators, sample reflectivity or opaqueness, etc., and 4) without the aid of a well calibrated motorized stage (i.e.; a manual stage) a large field of view image acquisition—without changing the objective magnification—is impossible.

Accordingly, a need exists for providing an improvement of the overall Cassegrain objective (i.e., a Schwarzschild Cassegrainian objective) as utilized in IR microscopes so as to enable the microscope to find the probed area in a time efficient manner. The present embodiments, as disclosed herein, addresses this need by utilizing an arrayed camera coupled to the secondary mirror of such an objective in a novel manner so as to enable a wide field of view for targeting desired sample regions to provide, among some aspects, quick and efficient use of the instrument.

### SUMMARY OF THE INVENTION

The present invention is directed to an Infrared (IR) microscope that is configured with a visible camera having its optical axis collinear with the (IR) and primary visible beampath of the microscope but outside the optical path that provides the image magnification. In particular, the Infrared (IR) microscope disclosed herein includes a reflective objective configured with a primary and a secondary mirror, wherein the primary and the secondary mirror causes incoming (IR) radiation to focus at a sample plane after passing through the reflective objective to form sample induced magnified imaging and spectroscopic information and an arrayed camera as coupled to the secondary mirror provides a wide field-of-view to enable ease of targeting regions of the sample when operating the (IR) system. It is to also be appreciated that the camera's optical axis is further configured to be collinear with the optical axis of the incoming (IR) radiation but outside the optical path so as to not interfere with the incoming (IR) radiation that provides magnified imaging and spectroscopic information.

Accordingly, the present provides for the integration of a large field of view camera and illumination means (e.g., LED multi-angle illuminators) that enables: 1) the video capturing of a significantly larger area than the one provided by the objective, 2) significantly reduces the video collection time (typically one frame instead of hundreds), which also improves the overall analysis time (cost) 3) provides brighter illumination than built in Abbe or Koehler type illuminators, which helps to cover a wider range of samples with different optical and surface properties and 4) opens the simplicity of finding specimens through large field of view observation to microscopes equipped with manual stage and single/fixed objective, hence significantly reducing the implied cost.

### BRIEF DESCRIPTION OF THE DRAWINGS

FIG. 1 shows an example microscope that can be configured with the enhanced Schwarzschild objective disclosed herein.

FIG. 2A and FIG. 2B respectfully show an example breakdown of the components that make up Schwarzschild Cassegrainian objective and the resultant assembly.

FIG. 3 shows an example embodiment of the Schwarzschild Cassegrainian objective configured with the visible far-field imaging arrangement(s) disclosed herein.

FIG. 4A shows an example far-field image using the visible imaging system as coupled to the Schwarzschild Cassegrainian objective.

FIG. 4B shows a magnified IR image provided by the Schwarzschild Cassegrainian objective as targeted by the visible imaging system shown in FIG. 4A.

### DETAILED DESCRIPTION

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

### General Description

As known to those of ordinary skill in the art, the Schwarzschild design is simply a reversal of the basic Cassegrain telephoto and because of its compactness; it is a desired configuration when utilized in IR applications. With respect to Schwarzschild Cassegrainian reflecting objectives as utilized in infrared (IR) microscopes, such as, Fourier Transform Infrared (FTIR) microscopes, the design of the objective offers good image quality over a wide range of wavelengths of radiant energy. The ability to image radiant energy at different wavelengths is important for contemporary microscopy because a sample is often examined with radiant energy at wavelengths ranging up to the far infrared.

While beneficial for IR applications, the long-standing problem aforementioned in the background section in the use of a Schwarzschild Cassegrainian objective; is the difficulty in locating desired target sample regions based on the inherent limited field of view. Because commonly applied visible imaging accessories upstream must use the same numerical aperture based on the reflective geometry, such systems also suffer a limited field of view. While the desired target region can nonetheless be found without the aid of such accessory imaging systems via, for example, mapping a larger area of the sample plane, the interrogation time frames can nonetheless result in an inefficient use of the instrument.

To overcome such difficulties, the novel embodiments herein involve placing a visible camera with its optical axis collinear with the (IR) and primary visible beampath of the microscope but outside the optical path that provides the image magnification. The camera itself is placed in a location so that it does not interfere with the rest of the IR beam or otherwise reduce the performance of the rest of the system. An example yet beneficial place to mount this camera so as to meet these criteria is the back side of the secondary mirror on the Cassegrain objective. A small camera can be placed there and fixed with an appropriate lens to show a wide field of view. Software can be used to switch between both the wide field and narrow field cameras to allow the user to quickly select an area of the sample. Another example embodiment is to use a fiber optic to mount the camera to the side of the objective and thread the fiber through the objective to point out the back of the secondary. As another beneficial aspect, imaging is made capable even in a dark room via one or more multi-angle illuminators (e.g., white light LEDs) as configured with the embodiments provided herein.

### Specific Description

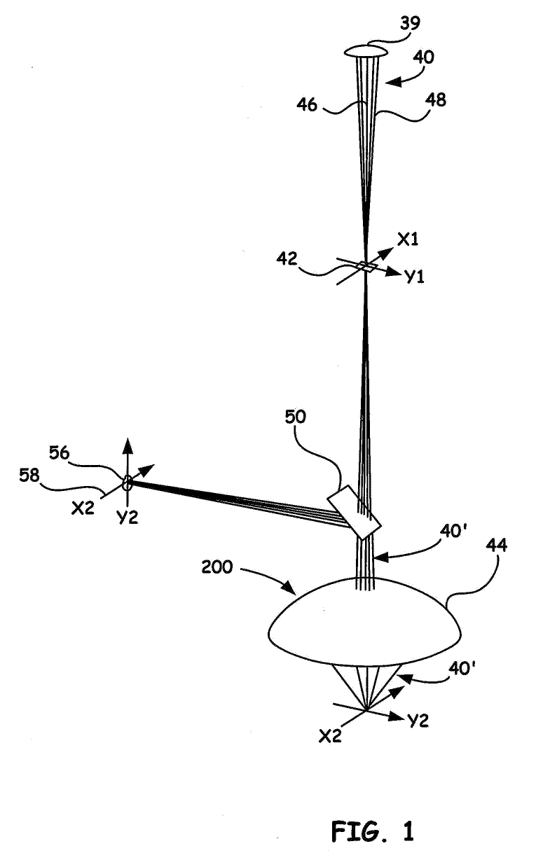

FIG. 1 graphically illustrates an example IR (e.g., FTIR) microscope that can be configured with the enhanced Schwarzschild objective 200 (note: only the primary mirror 44 is shown) embodiments of the invention. A beam 40 configured from one or more optical components 39 is provided from a modulated source (not shown). While a large number of rays are utilized, only 5 example rays of the beam 40 are shown for simplicity and ease of reading. The beam illuminates a large area at the “field” plane 42 (also shown with imaging directional arrows labeled X1 and Y1). This is also the back focal plane of the Schwarzschild objective 200. Two sets of exemplary rays are labeled, wherein ray 46 is incident at the center of the field plane and ray 48 is incident at an edge.

Half of the beam 40′ passes an interposed directional mirror 50, and is directed by the Schwarzschild objective 200 to a sample (not shown) having areas of interest configured at a sample plane denoted as x2, y2. The objective 200 can be configured with magnifications ranging from about 15× up to about 40×.

Due to the symmetry of the system, rays that reflect/scatter from the sample (not shown) situated at plane x2, y2, are imaged to a detector plane 56 (now shown with the imaging directional arrows rotated but again labeled x2, y2, with the same magnification factors involved, i.e., about a 1:1 imaging between the field plane 42 and the detector plane 56. A detector (not shown) at detector plane 56 can often be configured as a linear array of elements, oriented along the x axis (i.e., the arrow labeled 58 with respect to the detector plane 56).

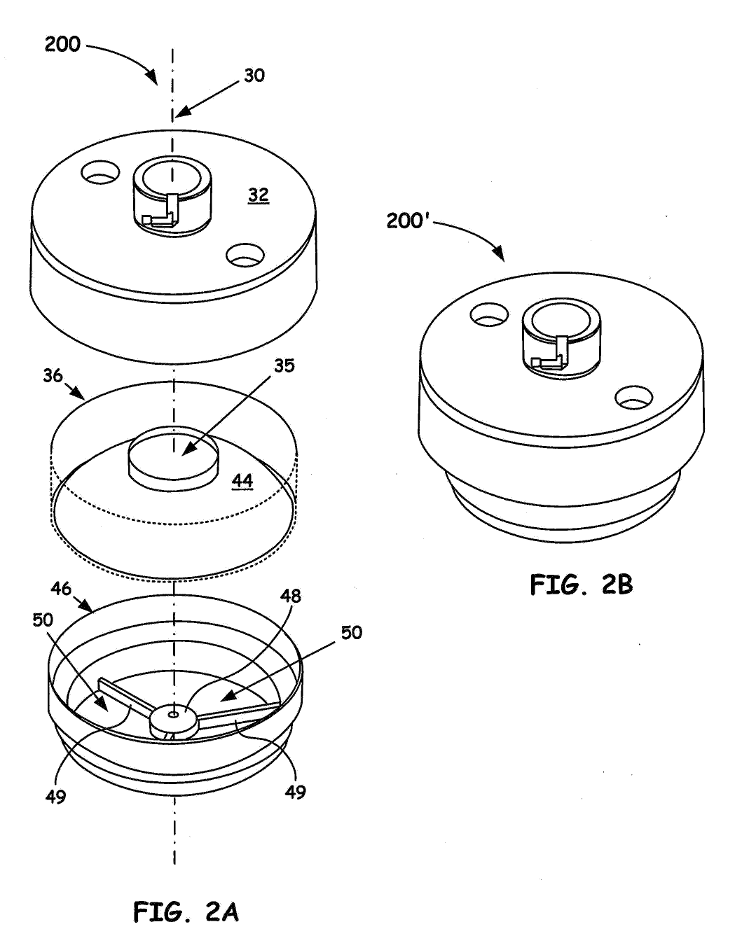

FIG. 2A graphically illustrates an example breakdown of the components that make up Schwarzschild objective 200 illustrated in FIG. 1. In particular, FIG. 2A shows an objective housing 32 configured to couple to a condenser compartment 46 in a manner (via threading means (not shown)) that enables a primary spherical mirror 44 within its compartment 36 (dashed phantom lines utilized to show primary mirror 44) to be set at predetermined distances from a designed secondary mirror 48 fixedly coupled to the condenser compartment 46. Specifically, with respect to the condenser compartment 46, it includes a spider assembly which essentially entails one or more constructed support structures 49 (spokes, beams, etc.) arranged to extend outward in a plane which is perpendicular to the centrally coupled secondary mirror 48. Also depicted in FIG. 2A is an aperture 35 configured within the primary mirror 44 to enable incoming directed optical energy to pass therethrough to the secondary mirror 48. Also of note are the openings 50 about the support structures 49 that enable resultant condensed light to be directed around such structures 49 and focused to a desired sample plane, as to be discussed in detail below. In such an arrangement, the secondary mirror 48 is thus configured with the primary mirror 44 that in a final assembled arrangement 200′ (as shown in FIG. 2B) provides for the disposed optical components (i.e., primary mirrors 44 and secondary mirror 48) to be set at desired distances and aligned on the optical axis 30 to provide for a desired Schwarzschild objective that can be utilized herein.

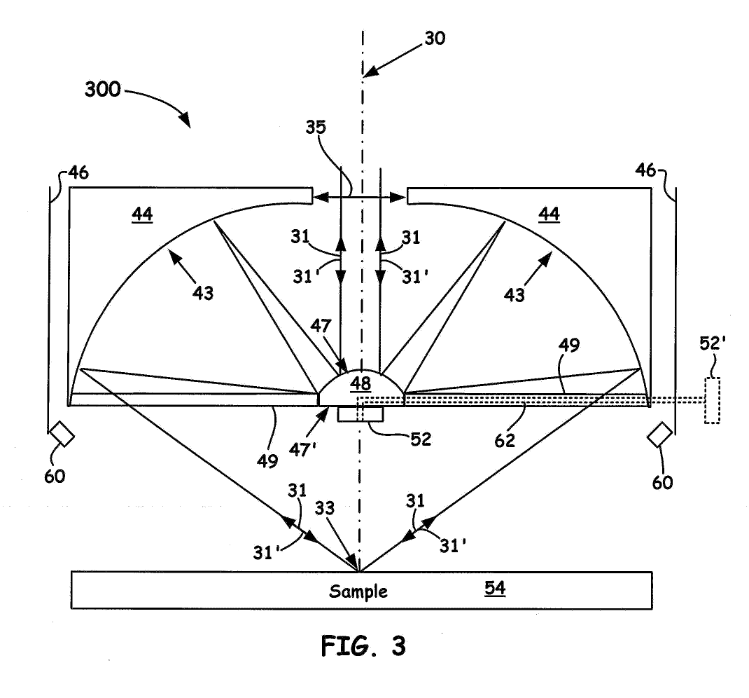

FIG. 3 shows a non-limiting example embodiment of the objective and visible far-field imaging arrangement, now generally denoted by the reference character 300, which in combination with FIG. 2A provides the reader of the present application an appreciation for the novelty and beneficial aspects of the disclosed configurations. Turning to the discussion of FIG. 3, the primary mirror 44 and the secondary mirror 48 are aligned along the optical axis 30 and disposed in the structures shown in FIG. 2A to provide for a Schwarzschild Cassegrainian microscope objective.

The primary mirror 44, as known to those skilled in the art, has a mirrored surface 43 and an aperture 35 (also denoted via a bi-directional arrow) designed to allow incoming optical interrogation energy 31 and outgoing optical spectroscopic/imaging information 31′ to pass therethrough (as also denoted by the bi-directional arrows along the resultant beampath). The incoming optical interrogation energy 31 passing therethrough aperture 35 thus reflects off of the mirrored surface 47 of the secondary mirror 48 and is redirected to the mirrored surface 43 of primary mirror 44 so as to eventually form a focus at a desired sample plane 33 (i.e., at a target site of a sample 54) after passing about the configured structures 49 that form the spider assembly, as discussed above for FIG. 2A. While FIG. 3 generally shows two reflections off of each mirrored surface 43, 47, it is to be appreciated that the number depends on the design constraints so as to enable, if desired, a desired fixed or variable magnification with a corresponding image quality for the objective 300 utilized herein.

As noted above in the general description, a key aspect of the configurations disclosed herein is the location of a camera 52 (e.g., an arrayed camera) often configured with a desired lens (not shown) so that it does not interfere with the incoming IR optical interrogation beam 31 or otherwise reduce the performance (e.g., optical throughput) of the rest of the system. In particular, as shown in FIG. 3, the camera is preferably coupled (e.g., via an adhesive) to the back side 47′ of the secondary mirror 48 on the Cassegrain objective 300.

As an alternative arrangement, a mount (not shown) for the secondary mirror 48 can be machined or formed so as to provide a cavity (not shown) that enables a small camera to be placed in a fixed position with an appropriate lens to show a wide field of view that is collinearly aligned with the overall objective 300. Thereafter, positional software controlled markers can find using the far-field image of the camera 52 a desired location to be targeted by the objective 300. Another example embodiment is to use a fiber optic 62 (shown as a dashed phantom set of lines) to mount the camera (also denoted in phantom and now referenced as 52′) to the side of the objective and thread the fiber through the objective to point out the back of the secondary mirror 48. As another arrangement, a turning prism (not shown) can be affixed to the distal end of the fiber optic 62 (i.e., at end situated by the secondary mirror 48 to turn the imaging information so as to overcome optical turning radii problems known in the field.

The operation of microscope shown in FIG. 1 having the objective shown in FIG. 3 can be controlled and data can be acquired by a control and data system (not depicted) of various circuitry of a known type, which may be implemented as any one or a combination of general or special-purpose processors (digital signal processor (DSP)), firmware, software to provide instrument control and data analysis for the instrument(s) disclosed herein. Such processing of the data may also include, but is not strictly limited to, averaging, deconvolution, spectral comparisons, library searches, data storage, and data reporting.

In addition, such instruction and control functions, as described above, can also be implemented by a system, as shown in FIG. 1, as provided by a machine-readable medium (e.g., a computer readable medium). A computer-readable medium, in accordance with aspects of the present invention, refers to mediums known and understood by those of ordinary skill in the art, which have encoded information provided in a form that can be read (i.e., scanned/sensed) by a machine/computer and interpreted by the machine's/computer's hardware and/or software. Such a system can also include a user-friendly graphical interface with selecting and clicking options to provide single-spectrum or multiple spectral collection as well as mapping applications over a desired area. All visible or (IR) images can be stored and retrieved by the user for display. When a targeted area is specified for data collection by the visible imaging system disclosed herein, a video image of that region can be captured for storage with a resultant data file and processed by the control and data system to enable, when desired, focusing of the sample via the microscope to provide (IR) data acquisition.

It is to be also noted that the camera 52 so chosen must be small enough (e.g., in diameter) in order to not protrude about the back side 47′ of the secondary mirror 48 so as to interfere with the (IR) interrogation radiation. Moreover, the camera 52 must also not be wide enough to interfere with the focusing ability of the objective 300 as the working distances (e.g., a working distance of about two centimeters) for such instruments are often small due to the reflective Cassegrain geometry. Power and image cables (not shown) coupled to the camera 52 can be arranged about, for example, one of the structures 49 of the spider assembly and directed to necessary hardware and software controls without also interfering with incoming radiation.

As another example arrangement to provide for enhanced image quality, one or more configured light sources 60 (e.g., white light LEDs) can be affixed about the condenser compartment 46 so that sufficient illumination is provided to the sample plane 33 when necessary. It is also to be appreciated that because the field of view of the objective is on the order of about 150 um up to about 500 um, a desired larger field of view for the camera 52 shown in FIG. 3 is often at least an order of magnitude, preferably at least about 2 mm up to about 20 mm, often about 5 mm up to about 10 mm.

The camera itself is often an arrayed camera such as a complementary-symmetry metal-oxide-semiconductor (CMOS) sensor commonly utilized in computers or cell phone technology. While CCDs is a more mature technology, CMOS cameras are less expensive to fabricate, and operate at lower supply voltages, and tend to consume less power. Consequently, CMOS devices do not produce as much waste heat as other forms of logic and are thus desirable for this application and provide for a more than adequate image quality of a targeted sample region when coupled to the objectives, as depicted herein. However, while a CMOS sensor is preferred, it is to be understood that if high-quality image data is required, a CCD camera can also be utilized as the camera 52 generally shown in FIG. 3. Moreover, while such cameras often include a Near Infrared filter (NIR) to block such radiation, the filter can be removed if desired from the camera when desiring (NIR) imaging.

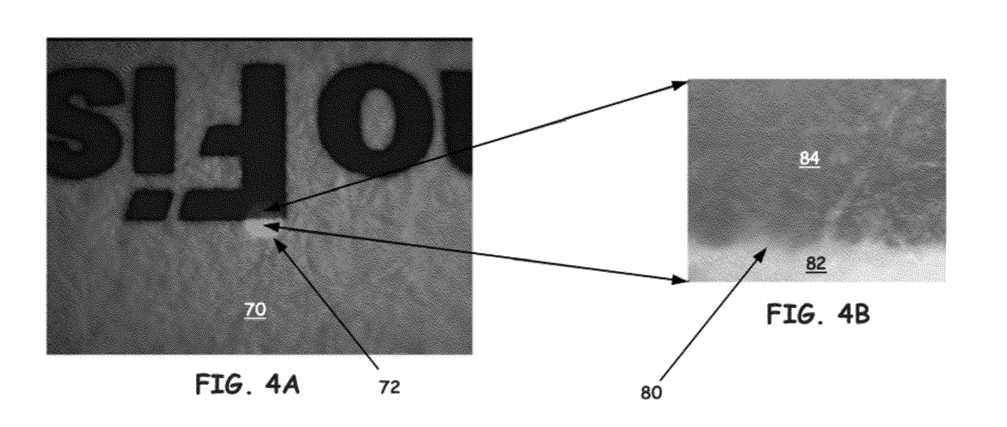

FIG. 4A shows an example camera image of printed material provided by a CMOS camera having a field of view of between 5-10 mm. A targeted region 72 (graphically shown as lightened area about a section of the letter F) is imaged by the CMOS camera using software automated controls and/or upon operator manipulation. Such a targeted region 72 is then spectroscopically investigated with the microscope objective 300 of FIG. 3, of which also enables the near field magnified image shown in FIG. 413. Note the contrast region 80 indicating the delineation between the paper substrate material 82 and the embedded dark lettering 84 section of the region about the letter F that was targeted by the arrayed camera, as shown in FIG. 4A.

It is to be understood that features described with regard to the various embodiments herein may be mixed and matched in any combination without departing from the spirit and scope of the invention. Although different selected embodiments have been illustrated and described in detail, it is to be appreciated that they are exemplary, and that a variety of substitutions and alterations are possible without departing from the spirit and scope of the present invention.

We claim:

1. An Infrared (IR) microscope, comprising:
a reflective objective configured with a primary and a secondary mirror, wherein said primary and said secondary mirrors causes incoming (IR) radiation to focus at a sample plane after passing through said reflective objective to form sample induced narrow field-of-view imaging information; and
an arrayed camera coupled to said secondary mirror so as to provide a wide field-of-view for targeting regions of said sample, wherein said camera's optical axis is further configured to be collinear with the optical axis of the incoming (IR) radiation but outside the optical path that provides the incoming (IR) narrow field-of-view imaging and spectroscopic information.

2. The microscope of claim 1, wherein said reflective objective comprises a Scwartzschild Cassegranian objective.

3. The microscope of claim 1, wherein said microscope is configured as a Fourier Transform Infrared (FTIR) microscope.

4. The microscope of claim 1, wherein said arrayed camera comprises at least one camera selected from a CMOS camera and a CCD camera.

5. The microscope of claim 4, wherein an inclusive Near Infrared filter (NIR) provided on said selected CMOS camera or CCD camera is removed to provide NIR imaging with said microscope.

6. The microscope of claim 1, wherein said arrayed camera comprises a field-of-view ranging from about 2 mm up to about 20 mm.

7. The microscope of claim 1, wherein said arrayed camera is configured to the side of said reflective objective and coupled to an optical fiber conduit mounted to said secondary mirror so as to provide a wide field-of-view for targeting regions of said sample, wherein the optical axis of said optical fiber conduit is collinear with the optical axis of the incoming (IR) radiation but outside the optical path that provides the incoming (IR) narrow field of view imaging information.

8. The microscope of claim 7, wherein the optical fiber conduit further comprises a turning prism affixed to a distal end so as to redirect imaging information.

9. The microscope of claim 1, wherein visible illumination is provided by one or more sources configured about the objective to aid said camera in imaging said sample plane.

10. The microscope of claim 9, wherein the visible illumination is provided by one or more white light LED sources.
